(19) United States
(12) Patent Application Publication
(10) Pub. No.: US 2025/0316192 A1
(43) Pub. Date: Oct. 9, 2025

(54) POWERLESS IMAGE CAPTURE GREETING CARD

(71) Applicant: Ronald Cullen Folmar, Escondido, CA (US)

(72) Inventor: Ronald Cullen Folmar, Escondido, CA (US)

(21) Appl. No.: 18/629,893

(22) Filed: Apr. 8, 2024

(51) Int. Cl. G09F 19/00; B42D 15/02

(52) U.S. Cl. CPC G09F 19/00; B42D 15/02

(57) ABSTRACT

The present disclosure relates to a powerless image capture greeting card. Particularly, the powerless image capture greeting card may include a front panel, an outer flexible display panel disposed on the front panel, an outer display input port connector coupled to the outer flexible display panel, and a frame member coupled to the front panel and disposed on a top side of the outer flexible display panel. In addition, the outer display input port connector may be configured to connect to a display circuit component for supplying a power source and rendering a display content to the outer flexible display panel, and the outer flexible display panel permanently retains the display content upon disconnection of the power source.

### FIELD OF THE DISCLOSURE

The present disclosure relates to a powerless image capture (PIC) greeting card. Particularly, the PIC greeting card is notably batteryless and does not require any power source to retain image, graphics, or text written on its flexible display, employing novel methods for writing graphics and images on the flexible display such as personalized messages, text, and graphics.

### BACKGROUND

Greeting cards have been used throughout the centuries by many cultures to convey thanks or communicate other feelings joy and sadness, expressing good will, appreciation, and sentiments to the intended recipient(s). Many forms of standard greeting cards are made out of a piece of card stock and customarily with written messages, poems, graphics, and/or photos. Most, if not all physical greeting cards are packaged using an envelope and come in a variety of shapes and styles. These styles of greeting cards may include, for example, handmade versions, die-cuts, pop-ups, musical, light-display, or glued-on decorations. In some aspects, messages and contents of many off-the-shelf greeting cards can be generic, vague, and boring, making it difficult for buyers to find the appropriate message or content which expresses their exact sentiments.

Electronic (also called e-cards) are a popular form of greeting cards can also be sent electronically via a text message, hyperlink, or by email. These types of e-cards are simple to use, have a wide selection of graphics and messages from which to choose, and are widely available and offered for free or at a very low cost by many online vendors. Because of their “virtual” nature, these e-cards lack the physical aspect offered only by standard greeting cards.

Video greeting cards are relatively new though not widely available, providing custom video messages to the end user. However, these cards are bulkly, relatively heavy, cannot fit into a standard mailing envelope, require a power source (i.e., battery), cost more to ship by mail, and are generally not safe for mail delivery due to required power components.

Therefore, it would be highly desirable to have a highly customizable standard size greeting card that is fully customizable and capable of capturing a one-time custom image on a front and/or inner side of the card without having to maintain any power source or memory in the card, making no changes to the standard greeting cards size and weight, adding virtually no additional postage cost, and allowing standard delivery by regular mail.

### SUMMARY

It is an advantage of the present disclosure to provide a powerless image capture greeting card including a front panel having one or more greeting card elements or embellishments applied thereon, an outer flexible display panel disposed on the front panel, an outer display input port connector coupled to the outer flexible display panel, a frame member coupled to the front panel and disposed on a top side of the outer flexible display panel. In addition, a portion of the frame member may form a window for exposing a display area of the outer flexible display panel, and the outer display input port connector may be configured to connect to a display circuit component for supplying a power source and rendering a display content to the outer flexible display panel. Subsequently, the outer flexible display panel may permanently retain the display content upon disconnection of the power source.

It is another advantage of the present disclosure to provide a method of rendering an image on a powerless image capture greeting card, the method including 1) connecting a powerless image capture greeting card to a display circuit component having at least one power source supplying power to the PIC greeting card upon connection, the powerless image capture greeting card having at least a flexible display panel disposed thereon; 2) generating a display content by one or more peripheral devices coupled to the display circuit component; 3) converting the display content to a pixel array data by the display circuit component; 4) transferring the pixel array data to the flexible display panel by the display circuit component; 5) rendering the display content, as performed by the display circuit component, on the flexible display panel based on the pixel array data; 6) disconnecting the powerless image capture greeting card from the display circuit component, thereby disconnecting the power supply to the flexible display panel; and 7) retaining the display content on the flexible display panel upon disconnection of the display circuit component where no power is drawn by the powerless image capture greeting card.

These and other objects, features and advantages of the present disclosure will become more apparent in light of the following detailed description of preferred embodiments thereof, as illustrated in the accompanying drawings.

### BRIEF DESCRIPTION OF THE DRAWINGS

The present disclosure will be more clearly understood from the following detailed description of the preferred embodiments of the disclosure and from the attached drawings, in which:

FIG. 1 illustrates a powerless image capture greeting card (or “PIC greeting card”) having a flexible display disposed on a front facing side of the card, according to an embodiment.

FIG. 2A-FIG. 2D illustrate a front, a side, a top, and a back view, respectively, of the PIC greeting card in its closed position, according to an embodiment.

FIG. 3 illustrates other aspects of the PIC greeting card in its partially opened position, according to an embodiment.

FIG. 4 illustrates the PIC greeting card coupled to a display circuit component via a wired connector cable or flex PCB connector coupling an FPC connector of the circuit component to the display port connector of the PIC greeting card, according to an embodiment.

FIG. 5 illustrates peripheral components supported by the display circuit component for generating display contents to the PIC greeting card, according to an embodiment.

FIG. 6A-FIG. 6D illustrate examples of text and graphical content rendered to the outer flexible display panel disposed on the front panel and inner flexible display panel disposed on the back panel of the PIC greeting card, according to an embodiment.

FIG. 7A-FIG. 7B illustrate a postcard version of the PIC greeting card, according to an embodiment.

FIG. 8A-FIG. 8D illustrate an application of the PIC greeting card with a standard greeting card envelope, according to an embodiment.

FIG. 9 illustrates an implementation of multiple flexibility displays disposed on the front panel, the back panel, or both panes of the PIC greeting card, according to an embodiment.

FIG. 10 illustrates another configuration of a stand-alone version of the PIC greeting card having an embedded display circuit component and peripherals disposed in the panel and frame members of the PIC greeting card, according to an embodiment.

FIG. 11 illustrates a flowchart of operating the PIC greeting card, according to an embodiment.

FIG. 12 illustrates a flowchart of operating the stand-alone PIC greeting card shown in FIG. 10, according to an embodiment.

FIG. 13 illustrates block diagrams of the PIC greeting card, the display circuit component, and auxiliary components, according to an embodiment.

FIG. 14 illustrates a pseudo-code algorithm executed by the display circuit component for programming the flexible display panel of the PIC greeting card, according to an embodiment.

In the appended figures, one or more elements may have the same reference numeral in different figures indicating previously described.

### DETAILED DESCRIPTION

In one aspect, some components of the present disclosure may employ technology based on electronic paper technology that simulates the look of ink on paper. Other commonly known technologies are known as an E-Ink display or Electronic Ink display. Some consumer electronic implementations of such technology are seen in electronic shelf labels, digital signs, and e-readers all frequently use it. The low power consumption, excellent visibility in a range of lighting conditions (including direct sunshine), and ability to retain a picture without electricity are all some desirable features of E-Ink displays. When exposed to an electric field, they reorganize charged pigment particles inside small capsules, producing a variety of black and white hues. In comparison to conventional LCD panels, this technology offers a reading experience similar to that of paper and greatly increases battery life.

Some aspects of the electronic paper technology may involve the use of flexible display panels, allowing some degree of bending and twisting. In another aspect, a high-contrast daylight readable monochrome or color image can be generated on the panel and remain thereon once power is removed.

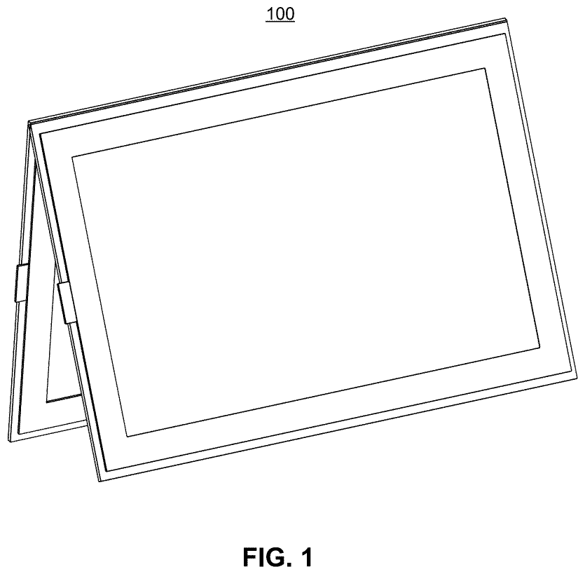

FIG. 1 illustrates a powerless image capture greeting card 100 (or “PIC greeting card”) having a flexible display disposed on a front facing side of the card, according to an embodiment. As used herein, the term “powerless” specifically refers to a non-battery powered greeting card for retaining an image, graphics, and/or text is rendered thereon. In one common application, users may apply a custom message, image, photo, or combination thereof to the front facing side of the PIC greeting card 100 via unique techniques described later herein. The PIC greeting card 100 is generally made to be no different than a standard greeting card in appearance, size, thickness, weight, and functionality, advantageously allowing a user to deliver the PIC greeting card 100 via regular envelope, postage, and mail delivery shipping methods without adding to cost, special packaging, or special handling instructions.

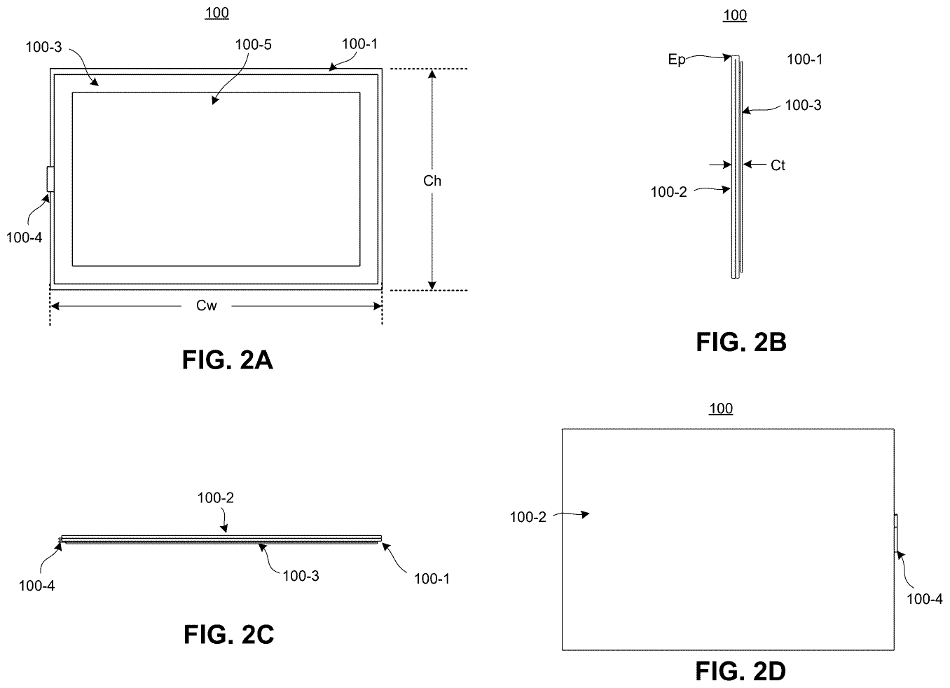

FIG. 2A-FIG. 2D illustrate a front, a side, a top, and a back view, respectively, of the PIC greeting card 100 in its closed position, according to an embodiment. Typical dimensions of the PIC greeting card 100 are configured to be the same or identical to most standard greeting cards, measuring 3″-11″ in width (Cw), 3″-7″ in height (Ch) and 0.05″-0.10″ in thickness (Ct). The PIC greeting card 100 may include a front panel 100-1, a back panel 100-2 coupled to the front panel 100-1 along a top edge portion (Ep) thereof, an outer flexible display panel 100-5 coupled to front panel 100-1, and a frame member 100-3 attached to the front panel 100-1 and disposed on a top side of the outer flexible display panel 100-5, where the frame member 100-3 also includes a border and a single central opening exposing a display area of the outer flexible display panel 100-5. In addition, an outer display input port connector 100-4 may be coupled to the outer flexible display panel 100-5 along a peripheral edge thereof. In one aspect, the panels and frame members (100-1, 100-2, and 100-3) may be made of card stock paper, recycled paper, plastic, wood, aluminum, composite plastic, or other type of semi-rigid materials. In another aspect, the front panel 100-1 and back panel 100-2 may be made from a single panel that is joined together by folding the single panel in half making two sides. In yet another aspect, the front panel 100-1 and back panel 100-2 may be held together along the top edge portion (Ep) via a hinge member (not shown) or other fastening permanent or temporary members (adhesives, hook-and-loop, magnetics, etc.)

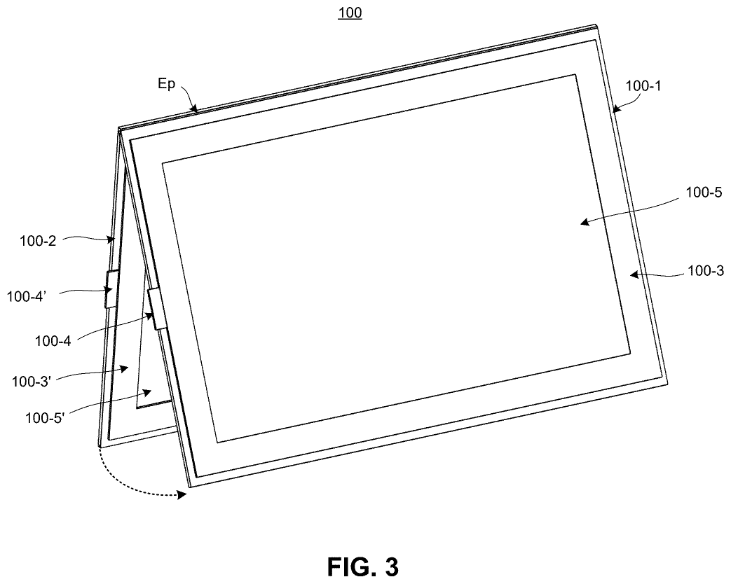

FIG. 3 illustrates other aspects of the PIC greeting card 100 in its partially opened position, according to an embodiment. Like most standard greeting cards, the PIC greeting card 100 may be opened by raising the front panel 100-1 along its bottom edge away from the back panel 100-2, thereby exposing a front-facing side of the back panel 100-2 of the e-greeting card 100. In yet another embodiment, the front-facing side of the back panel 100-2 may be structurally the same as the components on the front panel 100-1. For example, the front-facing side of the back panel 100-2 may include an inner flexible display panel 100-5′ coupled to the front-facing side of the back panel 100-2 and an inner frame member 100-3′ attached to the front-facing side of the back panel 100-2 and disposed on a top side of the inner flexible display panel 100-5′, where the inner frame member 100-3′ also includes a border and central opening exposing a display area of the inner flexible display panel 100-5′. An inner display port connector 100-4′ of the back panel 100-2 may be coupled to the inner flexible display panel 100-5′ along a peripheral edge thereof.

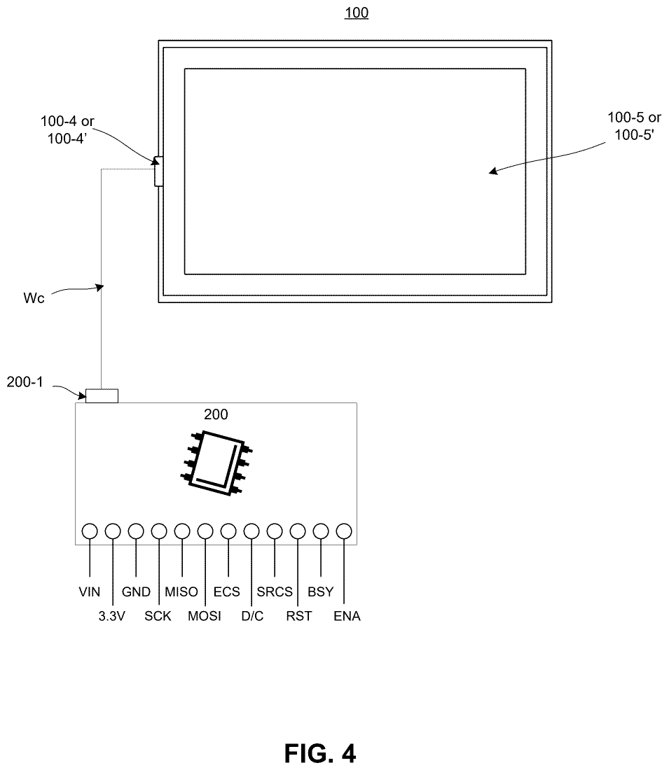

FIG. 4 illustrates the PIC greeting card 100 coupled to a display circuit component 200 via a wired connector cable or flex PCB connector Wc coupling an FPC connector 200-1 of the circuit component 200 to the display port connector (100-4 or 100-4′) of the PIC greeting card 100, according to an embodiment. In an implementation, the display circuit component 200 may include one or more chipset modules and drivers to control activating pixels for writing contents to the flexible display panel (100-5 or 100-5′). The chipset modules may also include firmware and memory which support programming libraries based on high-level, general-purpose programming language such as Python, Java, C++, C#, Visual Basic, and JavaScript which provide end-users a high-level programming and front-end user interface for generating custom written content to the to the flexible display panel (100-5 or 100-5′). The display port connector (100-4 or 100-4′) is configured to connect to the display circuit component 200 by which power is supplied and a display content is rendered ‘(or written) to the flexible display panel (100-5 or 100-5’). Once the display content is rendered to the flexible display panel (100-5 or 100-5′), the flexible display panel (100-5 or 100-5′) permanently retains the display content as rendered by the display circuit component 200 even after power is no longer supplied (i.e., when the display port connector (100-4 or 100-4′) is disconnected from a display circuit component 200).

In another aspect, the flexible display panel (100-5 or 100-5′) may utilize e-Ink or ePaper display technology capable of producing a high contrast, high reflectance, and ultra-wide viewing angle display and supporting multiple display formats with a pixel resolutions from approximately 200×100 pixels to 600×1200 pixels. In addition, power consumption of the flexible display panel (100-5 or 100-5′) are minimal requiring ultra-low current draw when connected and programmed by the display circuit component 200. Other supported modes of the flexible display panel (100-5 or 100-5′) may include a bi-stable display, wide operating temperature range, landscape and portrait modes, anti-glare surface, and a resilient scratch resistance surface.

In another aspect, the display circuit component 200 may include a display driver chipset electronically coupled with PCB components having pinout connectors for power control, data flow control, memory control, clock settings, and display settings. Examples display driver chipsets employed by the display circuit component 200 may include, but are not limited to, the ESP32 by Waveshare (trademark of Shenzhen Weixue Electronic Co., Ltd., Futian, Shenzhen CHINA) or the UC8151D Adafruit Industries (trademark of Adafruit Industries, New York, NEW YORK). Sample pin-out connectors on the PCB component may include:
3-5V/Vin—power pin, connect to 3-5 VDC with reverse polarity protection.
3.3V out—3.3V output from the onboard regulator; supply power from other onboard 3.3V logic devices.
GND—power and signal ground pin.
ENAble—enable power for unit. Supply initial power to the display.
SCK—SPI clock input pin, required for e-Ink, SRAM and SD card.
MISO—SPI Microcontroller In Serial Out pin used for the SD card and SRAM.
MOSI—SPI Microcontroller Out Serial In pin used for sending data from the microcontroller to the SD card, SRAM and e-Ink display.
ECS—E-Ink Chip Select required for controlling the display.
D/C—e-Ink Data/Command pin, required for controlling the display.
SRCS—SRAM Chip Select required for communicating with the onboard RAM chip.
SDCS—SD card Chip Select required for communicating with the onboard SD card holder.
RST—E-Ink ReSeT pin, to control reset of the microcontroller.
BUSY—e-Ink busy detect pin which is optional for setting wait signal for an approximate number of seconds.

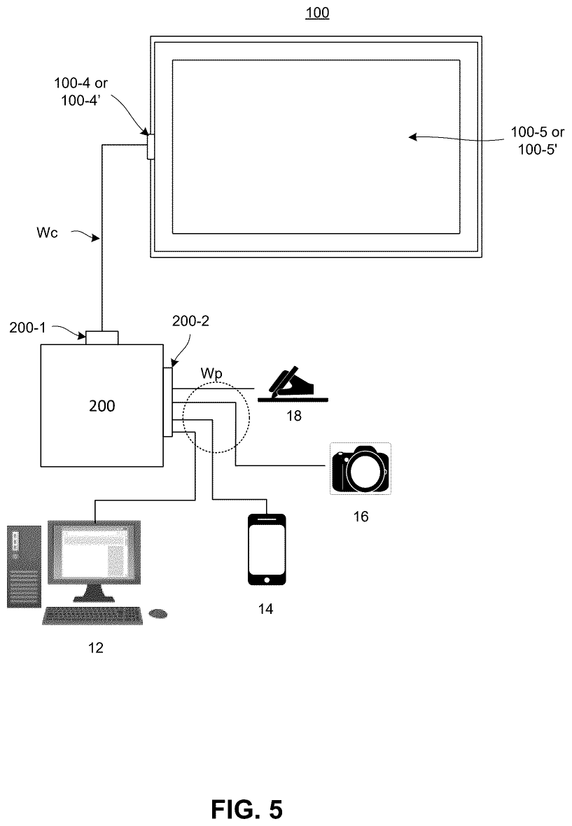

FIG. 5 illustrates peripheral components supported by the display circuit component 200 for generating display contents to the PIC greeting card 100, according to an embodiment. These peripheral components may include but are not limited to a computer 12, a mobile computing device 14 (e.g., smartphone, PDA, tablet), a digital camera 16, or a digital writing tablet 18. The display circuit component 200 may include an input/output (I/O) port 200-2 for communicating and receiving digital signals and information from the peripheral components over peripheral wired cables Wp, processing and then converting the received digital information into a display pixel format which is transmitted to the flexible display panel 100-5 for display configuration via the wired cable Wc connecting the FPC connector 200-1 to the display port connector (100-4 or 100-4′). In one aspect, the peripheral components may provide the user a graphical user interface by which they may create and upload custom messages, images, and graphics to the flexible display panel (100-5 or 100-5′) of the PIC greeting card 100. In another aspect, examples of input/output (I/O) port 200-2 may include but is not limited to serial ports, parallel ports, and USB Ports. In yet another instance, power to the inner and outer flexible display panels (100-5 and 100-5′) may be supplied separately with separate wired cables Wc or by a single wired cables Wc having a dual-adapter connector that plugs into both display port connector (100-4 or 100-4′).

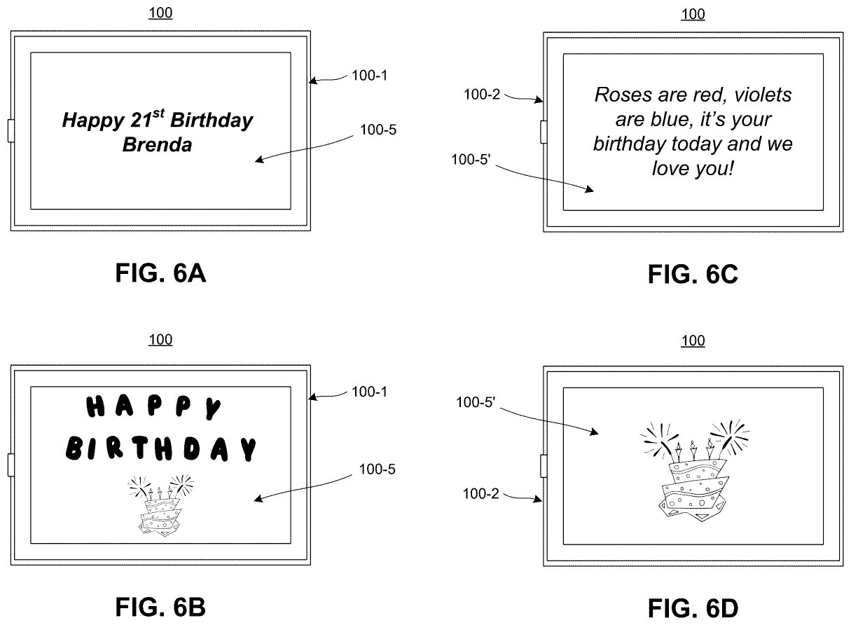

FIG. 6A-FIG. 6D illustrate examples of text and graphical content rendered to the outer flexible display panel 100-5 disposed on the front panel 100-1 (shown in FIG. 6A-FIG. 6B) and inner flexible display panel 100-5′ disposed on the back panel 100-2 (shown in FIG. 6C-FIG. 6D) of the PIC greeting card 100, according to an embodiment. In one instance, the PIC greeting card 100 is made to have two independent displays (the inner and outer flexible display panels (100-5 and 100-5′), allowing the user to create unique messages on both panels via the display circuit component 200. In another instance, the user may apply a text only message on the outer flexible display panel 100-5 (shown in FIG. 6A) or apply a combination of images, photos, graphics, and text messages to the outer flexible display panel 100-5 (shown in FIG. 6B). Similarly, the user may apply a text only message on the inner flexible display panel 100-5′ (shown in FIG. 6C) or apply a combination of image and text to the inner flexible display panel 100-5′ (shown in FIG. 6B) which can contain a different images, photos, messages and graphics than contents created on the outer flexible display panel 100-5.

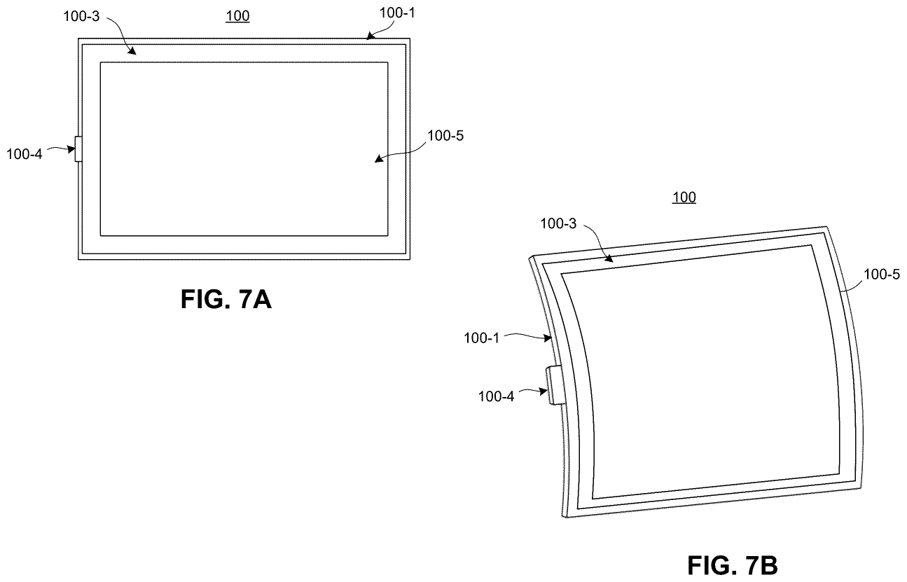

FIG. 7A-FIG. 7B illustrate a postcard version of the PIC greeting card 100, according to an embodiment. Unlike in the previous embodiment having two panels (100-1 and 100-2), the postcard version of the PIC greeting card 100 has only a single panel. In the postcard version, the frame member 100-3, display input port connector 100-4, and flexible display panel 100-5 are disposed on a single front panel 100-1, excluding the back panel. In the both postcard and two-panel versions of the PIC greeting card 100, the entire panels including the flexible display panel 100-5 are structured to be durable yet sufficiently flexible to withstand normal to moderate twisting or bending as shown in FIG. 7B.

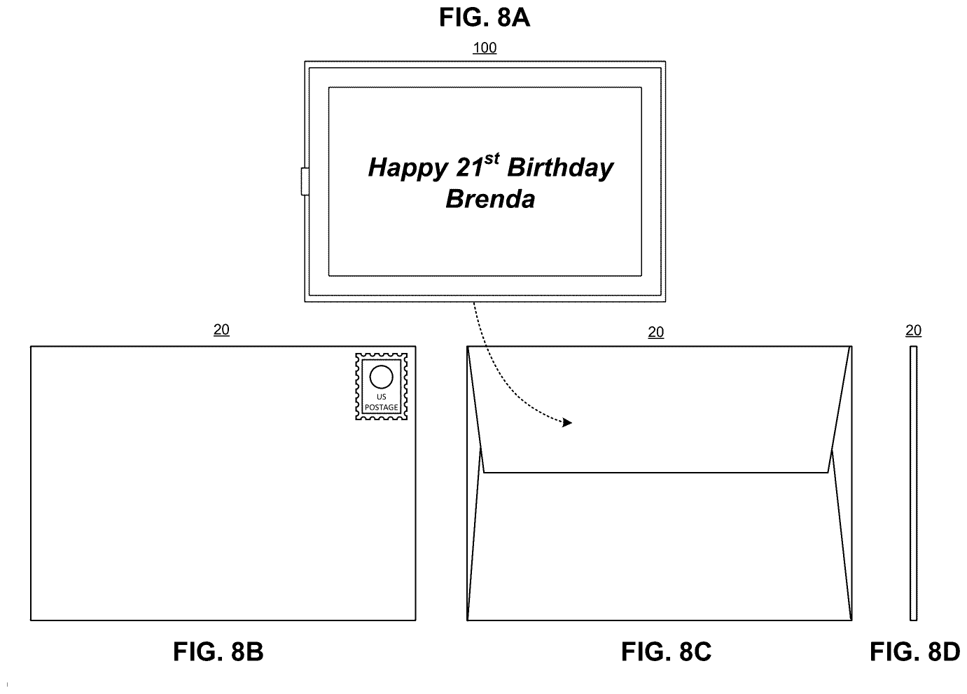

FIG. 8A-FIG. 8D illustrate an application of the PIC greeting card 100 with a standard greeting card envelope, according to an embodiment. As mentioned hereinabove, the PIC greeting card 100 is essentially no different than a standard greeting card in almost all aspects of appearance as well as in functionality. FIG. 8B-FIG. 8D respectively depicts a front, a back, and a side view of a standard A6 (4″×6″) envelope 20 with postage into which the PIC greeting card 100 may be inserted and enclosed without any special modification to the standard A6 envelope 20. Advantageously, an important aspect of the PIC greeting card 100 is the use of standard sized greeting cards for mail delivery, making it postage friendly and not requiring special packaging, or special handling instructions to safely deliver it by regular mail.

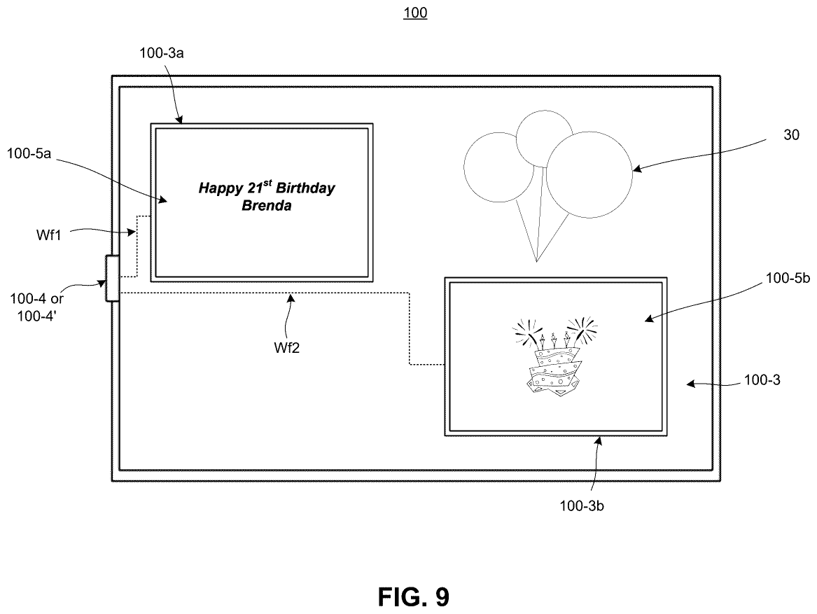

FIG. 9 illustrates an implementation of multiple flexibility displays disposed on the front panel 100-1, the back panel 100-2, or both panes of the PIC greeting card 100, according to an embodiment. In one aspect, instead of the frame member 100-3 having single central opening as described in the previous embodiment, the frame member 100-3 may have two or more cut-out regions (100-3a and 100-3b) rendered to the panel (100-1 or 100-2) for both securing and exposing two separate display regions of the multiple flexibility displays (100-5a and 100-5b). The display port connector (100-4 or 100-4′) may be coupled to the multiple flexibility displays (100-5a and 100-5b) via wire FPC cables (Wf1, Wf2) embedded in the frame member 100-3 through which the multiple flexibility displays (100-5a and 100-5b) may be simultaneously programmed and written by the display circuit component 200 when connected thereto. Other prefabricated elements 30 such as graphics, images, text or 3D accessories (i.e., glitter, buttons, embossments, embellishments etc.) may be applied or attached alongside the multiple flexibility displays (100-5a and 100-5b) for enhanced aesthetics and appearance.

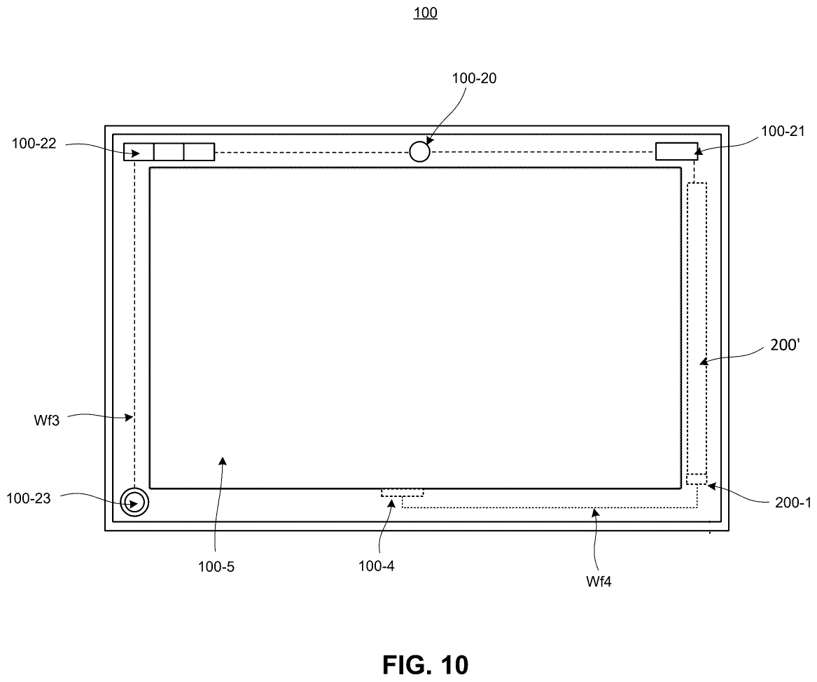

FIG. 10 illustrates another configuration of a stand-alone version of the PIC greeting card 100 having an embedded display circuit component and peripherals disposed in the panel and frame members of the PIC greeting card 100, according to an embodiment. The stand-alone version of the PIC greeting card 100 may include the flexible display panel 100-5 as previously described, an image capturing device 100-20, an LED flash 100-21, photovoltaic cells 100-8, a capture button 200-23 which are coupled to an embedded display circuit component 200′ via frame embedded wire FPC cables Wf3. In addition, the port connector 100-4 of the flexible display panel 100-5 may be connected to the FPC connector 200-1 of the embedded display circuit component 200′ via another frame embedded wire FPC cables Wf4. In one instance, the embedded display circuit component 200′ may include a microprocessor and I/O controllers to control peripheral components (flash and camera), receive power from the photovoltaic cells 100-22, receive capture inputs signals via the capture button 200-23, and transmit a display pixel format to the flexible display panel 100-5. The embedded display circuit component 200′ may internally integrated within an internal portion of the frame member 100-3 so that the circuit component 200′ is concealed and hidden from the front facing side of the PIC greeting card 100. In operation, an image is configured to be written to the flexible display panel 100-5 when the capture button 200-23 is triggered (i.e., depressed) by a user an LED flash 100-21

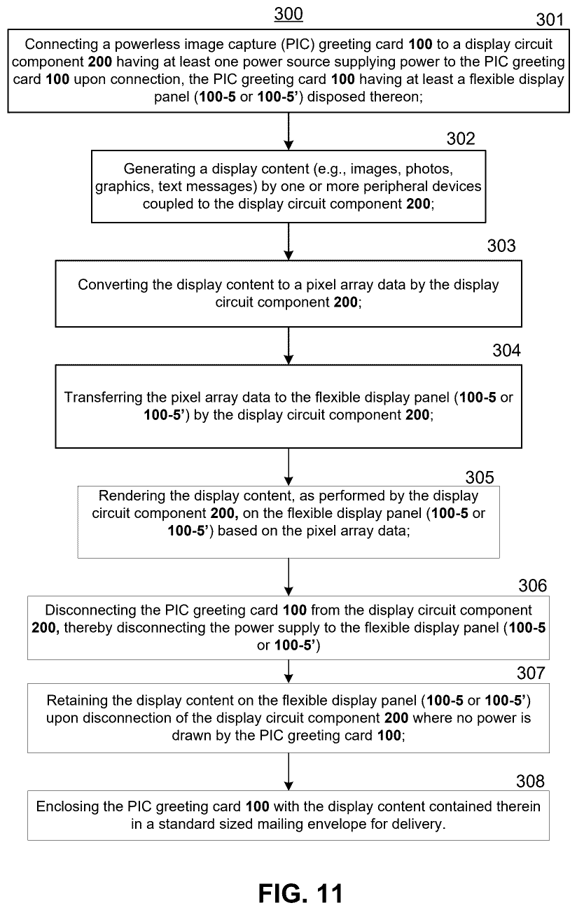

FIG. 11 illustrates a flowchart of operating the PIC greeting card 100, according to an embodiment. The flowchart in this implementation provides operating methods of connecting devices, preparing content, and using standard envelopes associated with the PIC greeting card 100, including the steps of:
1) Connecting a powerless image capture (PIC) greeting card 100 to a display circuit component 200 having at least one power source supplying power to the PIC greeting card 100 upon connection, the PIC greeting card 100 having at least a flexible display panel (100-5 or 100-5′) disposed thereon; (Step 301)
2) Generating a display content (e.g., images, photos, graphics, text messages) by one or more peripheral devices coupled to the display circuit component 200; (Step 302)
3) Converting the display content to a pixel array data by the display circuit component 200; (Step 303)
4) Transferring the pixel array data to the flexible display panel (100-5 or 100-5′) by the display circuit component 200; (Step 304).
5) Rendering the display content, as performed by the display circuit component 200, on the flexible display panel (100-5 or 100-5′) based on the pixel array data; (Step 305)
6) Disconnecting the PIC greeting card 100 from the display circuit component 200, thereby disconnecting the power supply to the flexible display panel (100-5 or 100-5′); (Step 306)
7) Retaining the display content on the flexible display panel (100-5 or 100-5′) upon disconnection of the display circuit component 200 where no power is drawn by the PIC greeting card 100; (Step 307)
8) Enclosing the PIC greeting card 100 with the display content contained therein in a standard sized mailing envelope for delivery. (Step 308)

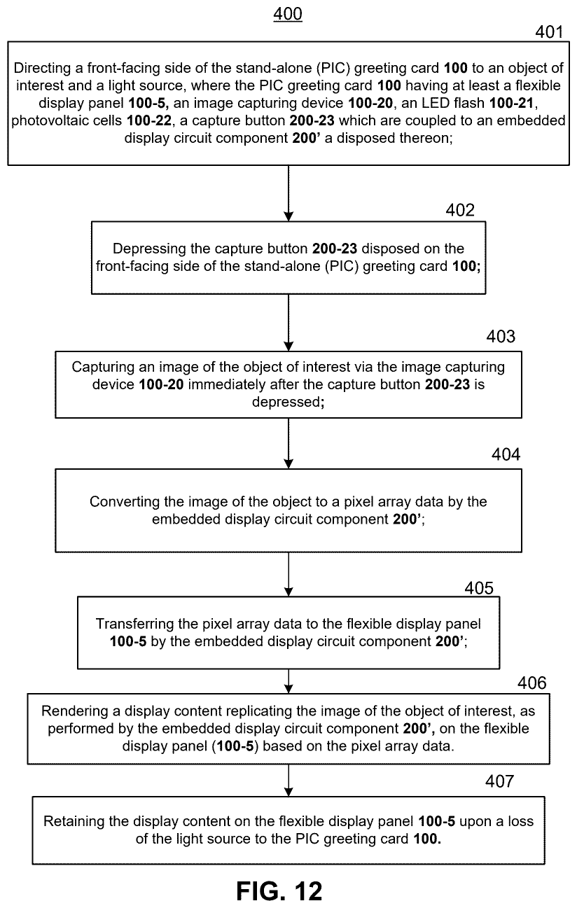

FIG. 12 illustrates a flowchart of operating the stand-alone PIC greeting card 100 shown in FIG. 10, according to an embodiment. The flowchart in this stand-alone implementation provides operating methods of connecting devices, preparing content, and using standard envelopes associated with the PIC greeting card 100, including the steps of:
1) Directing a front-facing side of the stand-alone (PIC) greeting card 100 to an object of interest and a light source, where the PIC greeting card 100 having at least a flexible display panel 100-5, an image capturing device 100-20, an LED flash 100-21, photovoltaic cells 100-22, a capture button 200-23 which are coupled to an embedded display circuit component 200′ a disposed thereon; (Step 401)
2) Depressing the capture button 200-23 disposed on the front-facing side of the stand-alone (PIC) greeting card 100; (Step 402).
3) Capturing an image of the object of interest via the image capturing device 100-20 immediately after the capture button 200-23 is depressed; (Step 403)
4) Converting the image of the object to a pixel array data by the embedded display circuit component 200′; (Step 404)
5) Transferring the pixel array data to the flexible display panel 100-5 by the embedded display circuit component 200′; (Step 405)
6) Rendering a display content replicating the image of the object of interest, as performed by the embedded display circuit component 200′, on the flexible display panel (100-5) based on the pixel array data. (Step 406)
7) Retaining the display content on the flexible display panel 100-5 upon a loss of the light source to the PIC greeting card 100. (Step 307)

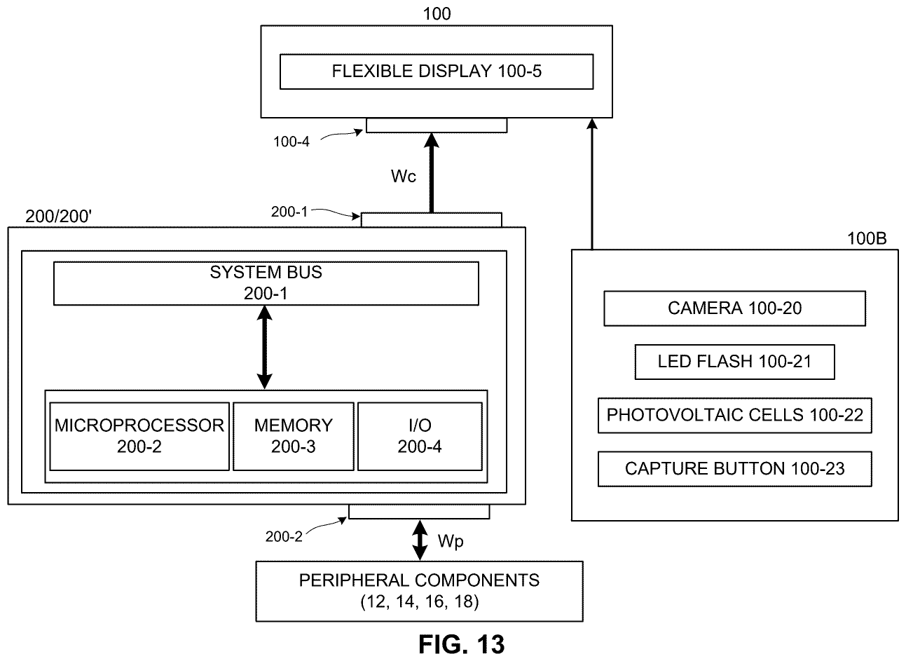

FIG. 13 illustrates block diagrams of the PIC greeting card 100, the display circuit component (200, 200′), and auxiliary components 100B, according to an embodiment. In the block diagram representing the PIC greeting card 100, the primary functional component contained therein is the flexible display panel (100-5 or 100-5′) for displaying configurable images, graphics, and text information as processed by the display circuit component (200, 200′). The flexible display panel (100-5 or 100-5′) of the PIC greeting card 100 is housed and supported by the panel and frame members of the PIC greeting card 100. With a programmable display screen, the flexible display panel (100-5 or 100-5′) can be customized by an end user via the display circuit component (200, 200′) when connected to it.

In the block diagram representing the display circuit component (200, 200′), key components therein may include a microprocessor 200-2, memory 200-3, and input/output (I/O) 200-4 which are all connected to one another via a system bus 200-1 by which data, address, and control information are communicated to the flexible display panel (100-5 or 100-5′) and/or peripheral components (12, 14, 16, and 18) over wired connectors (Wc, Wp). The system bus 200-1 may include an Address Bus, a Data Bus, and a Control Bus having different data transfer modes and being dedicated to specific memory-related actions. For example, the Address Bus transfers data from processor to memory or from microprocessor to I/O devices unidirectionally (single direction), having a width which determines the amount of physical memory addressable by the microprocessor. For the Data Bus, data transfer flows bidirectionally (in two directions), allowing data to transfer between the microprocessor (or CPU) and memory (e.g., RAM). The width of Data Bus indicates the size of the data transferred between the processor and memory or I/O device. The Control Bus is also bidirectional used by microprocessor for communicating with other devices within the computer. It is generally responsible for communicating control signals from microprocessor. Typical control signals may include memory read, memory write, I/O read, I/O write, bus request, indicating various types of actions occurring in the computing device (i.e., display circuit component). The microprocessor 200-2 of the display circuit component (200, 200′) performs logic and control for data processing and integrated onto one integrated circuit (IC). In operation, the microprocessor 200-2 is responsible for comprehending, interpreting, and executing program instructions and mathematical calculations. Furthermore, the microprocessor 200-2 is clock-driven, register-based, and multipurpose, receiving binary data as input and processing it in accordance with binary instructions stored in memory, and generating outputs results in binary form. Binary instructions include binary numbers and symbols to represent numbers and symbols, and they are equipped with both combinational and sequential digital logic. The memory 200-3 of the display circuit component (200, 200′) stores all data and instructions in binary form which are accessible and processed by the microprocessor 200-2.

In the block diagram representing the auxiliary components 100B, primary functional components may include the image capturing device 100-20, the LED flash 100-21, photovoltaic cells 100-22, a capture button 200-23 and may be provided in a separate implementation which is not required

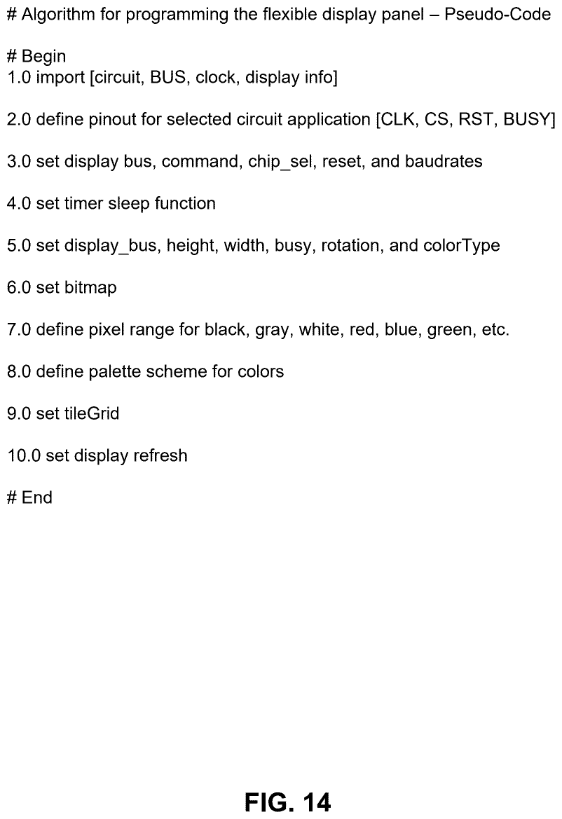

FIG. 14 illustrates a pseudo-code algorithm executed by the display circuit component (200, 200′) for programming the flexible display panel (100-5 or 100-5′) of the PIC greeting card 100, according to an embodiment. For example, the pseudo-code algorithm includes core instructions executed by the display circuit component (200, 200′) for importing internal and internal environmental variables, defining pinout parameters for selected circuit configurations, and setting display parameters applied to the flexible display panel (100-5 or 100-5′).

As used in the specification and the appended claims, the singular forms “a”, “an”, and “the” included plural referents unless the context clearly dictates otherwise.

It should be noted that the disclosure that came before this one was made only as an explanation and should not be interpreted as restricting the disclosure that is being made now. While multiple preferred embodiments of the present disclosure have been shown and described, it is possible to make various modifications, additions, and omissions to its form and detail without going outside the scope and spirit of the disclosure. It is acknowledged that the terms employed here are not terms of limitation, but rather terms of description and illustration. Within the parameters of the attached claims, both as revised and as stated currently, modifications are permissible as long as they don't deviate from the spirit and scope of the current disclosure in any way.

With these teachings, those with ordinary ability in the art may come up with further embodiments and modifications of the current disclosure. In light of the foregoing specifications and related drawings, the disclosure is to be limited only by the following claims which include all other such embodiments and modifications when viewed in conjunction with the above specifications and accompanying drawings.

What is claimed is:

1. A powerless image capture greeting card comprising:
a front panel having one or more greeting card elements or embellishments applied thereon;
an outer flexible display panel disposed on the front panel;
an outer display input port connector coupled to the outer flexible display panel;
a frame member coupled to the front panel and disposed on a top side of the outer flexible display panel, wherein a portion of the frame member forms a window for exposing a display area of the outer flexible display panel; and
wherein the outer display input port connector is configured to connect to a display circuit component for supplying a power source and rendering a display content to the outer flexible display panel, wherein the outer flexible display panel permanently retains the display content upon disconnection of the power source.

2. The powerless image capture greeting card of claim 1, further comprising a secondary outer flexible display panel is disposed on the front panel, wherein the outer display input port connector is coupled to the secondary outer flexible display panel.

3. The powerless image capture greeting card of claim 1, wherein the powerless image capture greeting card has a height, a width, and a thickness that fits inside an A6 mailing envelope.

4. The powerless image capture greeting card of claim 1, wherein one or more peripheral components are connected to the display circuit component for generating the display content.

5. The powerless image capture greeting card of claim 4, wherein the one or more peripheral components include a smartphone, computer, a digital camera, or a digital writing tablet.

6. The powerless image capture greeting card of claim 1, wherein the outer flexible display panel includes a flexible e-Ink display panel or flexible e-Paper display panel.

7. The powerless image capture greeting card of claim 1, wherein the front panel and the frame member are composed of card stock paper, recycled paper, plastic, wood, or composite plastic.

8. The powerless image capture greeting card of claim 1, wherein the outer display input port connector of the outer flexible display panel is coupled to the display circuit component via a wired connector.

9. The powerless image capture greeting card of claim 1, wherein the display content includes images, photos, graphics, text messages, or a combination thereof.

10. A powerless image capture greeting card comprising:
a front panel having one or more greeting card elements or embellishments applied thereon;
an outer flexible display panel disposed on the front panel;
an outer display input port connector coupled to the outer flexible display panel;
a frame member coupled to the front panel and disposed on a top side of the outer flexible display panel, wherein a portion of the frame member forms a window for exposing a display area of the outer flexible display panel;
a back panel coupled to the front panel along a top edge portion thereof.
an inner flexible display panel disposed on the back panel;
an inner display input port connector coupled to the inner flexible display panel; and
an inner frame member coupled to the back panel and disposed on a top side of the inner flexible display panel, wherein a portion of the inner frame member forms an inner window for exposing an inner display area of the inner flexible display panel;
wherein the outer display input port connector and inner display input port connector are configured to connect to a display circuit component for supplying a power source to the outer and inner flexible display panels, rendering a first display content to the outer flexible display panel, and rendering a second display content to the inner flexible display panel upon connection, wherein the outer flexible display panel permanently retains the first display content and the inner flexible display panel permanently retains the second display content upon disconnection of the power source.

11. The powerless image capture greeting card of claim 10, further comprising a secondary outer flexible display panel disposed on the front panel, wherein the outer display input port connector is coupled to the secondary outer flexible display panel.

12. The powerless image capture greeting card of claim 10, wherein the powerless image capture greeting card has a height, a width, and a thickness that fits inside an A6 mailing envelope.

13. The powerless image capture greeting card of claim 10, wherein one or more peripheral components are connected to the display circuit component for generating the first display content and second display content.

14. The powerless image capture greeting card of claim 13, wherein the one or more peripheral components include a smartphone, computer, a digital camera, or a digital writing tablet.

15. The powerless image capture greeting card of claim 10, wherein the outer flexible display panel includes a flexible e-Ink display panel or flexible e-Paper display panel.

16. The powerless image capture greeting card of claim 10, wherein the front panel and the frame member are composed of card stock paper, recycled paper, plastic, wood, or composite plastic.

17. The powerless image capture greeting card of claim 10, wherein the outer display input port connector of the outer flexible display panel is coupled to the display circuit component via a wired connector.

18. The powerless image capture greeting card of claim 10, wherein the front panel and the back panel held together along the top edge portion via a hinge member or fastening member.

19. The powerless image capture greeting card of claim 10, wherein the first and second display contents include images, photos, graphics, text messages, or a combination thereof.

20. A method of rendering an image on a powerless image capture greeting card, the method comprising:
connecting a powerless image capture greeting card to a display circuit component having at least one power source supplying power to the powerless image capture greeting card greeting card upon connection, the powerless image capture greeting card having at least a flexible display panel disposed thereon;
generating a display content by one or more peripheral devices coupled to the display circuit component;
converting the display content to a pixel array data by the display circuit component;
transferring the pixel array data to the flexible display panel by the display circuit component;
rendering the display content, as performed by the display circuit component, on the flexible display panel based on the pixel array data;
disconnecting the powerless image capture greeting card from the display circuit component, thereby disconnecting the power supply to the flexible display panel; and
retaining the display content on the flexible display panel upon disconnection of the display circuit component when power is withdrawn to the powerless image capture greeting card.
